(19) United States
(12) Patent Application Publication
(10) Pub. No.: US 2017/0271915 A1
(43) Pub. Date: Sep. 21, 2017

(54) Energy Demand Monitoring System and Smart micro-Grid Controller

(71) Applicant: Why Energy, LLC, Tucson, AZ (US)

(72) Inventors: Derek R. Quinn, Laguna Niguel, CA (US); MIchael J. Naifeh, Tucson, AZ (US); Arthur A. Andrew, Newport Beach, CA (US)

(21) Appl. No.: 15/461,264

(22) Filed: Mar. 16, 2017

Related U.S. Application Data
(60) Provisional application No. 62/390,024, filed on Mar. 16, 2016.

(51) Int. Cl. H02J 9/06; G06Q 50/06; G06F 1/14; G05B 15/02

(52) U.S. Cl. CPC H02J 9/061; G05B 15/02; G06Q 50/06; G06F 1/14; H04L 67/10

(57) ABSTRACT

An electronic monitoring system comprises an analog front end that receives as input the output of a current transformer connected to a load, wherein the analog front end converts the input to a digital value, a micro controller electrically connected to the analog front end that receives the digital value from the analog front end and pushes the digital value to a cloud server. A method of using an energy monitoring control system comprising the steps of: obtaining power consumption data from a plurality of nodes in an electrical grid; converting the power consumption data from analog to digital; sending the power consumption data in a digital format to a cloud server via a Wi-Fi connection; analyzing the power consumption data with a cloud based software program, and determining both historical and instantaneous power consumption data for one or more of the plurality of nodes based on the analysis.

### CROSS-REFERENCE TO RELATED APPLICATIONS

The present application claims benefit of and priority from U.S. Provisional Application No. 62/390,024 filed on Mar. 16, 2016 and titled “Synergy electronic monitoring, analyzing, and control system”. The disclosure of the above-mentioned patent application is incorporated herein by reference in its entirety.

### TECHNICAL FIELD

The present invention relates to electrical energy monitoring devices and, more particularly, to systems and methods for collecting and analyzing electrical power use data at the branch circuit level, i.e., downstream from a meter or grid connection. Embodiments of the invention further relate to transmission of collected data to a cloud server for analysis of usage, trends, and control capability. Further embodiments are directed to systems for disconnecting a randomly defined local energy grid (“micro grid”), for example, within a facility, from the broader utility grid (“macro grid”) and operating the micro grid autonomously or independently.

### BACKGROUND

Electrical monitoring systems monitor and provide reporting on current, voltage, power, and/or energy usage. Smart Meters provided by the utility companies are only capable of recognizing cumulative power used and peak demand. A Smart-Meter does not measure power for separate nodes, i.e., for separate branch circuits within an installation. in other words, the resolution of a Smart-Meter limited to that is measured at the meter, where it can monitor only the energy going in or surplus coming out. While some utility companies purport to provide data on power usage of individual loads within an installation (e.g., “heating”, “HVAC”, etc.), these data are typically estimates based on typical usage that are scaled according to the total power use measured at the meter. Thus, while existing electrical monitoring systems are capable of monitoring energy use, the data is at too low a resolution to be useful, and effective delivery of the collected data is primarily limited to local use. Some existing systems use a Power-Line-Communications (PLC) implementation, but this type of implementation results in an unusable product in complex customer situations. Thus, there is a need for an electrical monitoring system that provides reporting of the collected data in a format and delivery system that is not limited to local use in that can be accessed remotely, is not limited by the complexity of the/a user's electrical layout, and includes data collected at the branch circuit level.

Traditionally, a micro grid is recognized as a localized grouping of electricity sources and loads that normally operates connected to, and synchronous with the centralized grid (macro grid), but can disconnect and function autonomously as physical and/or economic conditions dictate. For example, a hospital that incorporates back-up generators that provide electricity during an electrical outage. Existing monitoring systems fail to address potential benefits of incorporating the ability to disconnect from the macro grid. With the increase of various alternative electricity sources, for example, solar panels, there is a need for a monitoring and control system that, based on the monitored conditions of power consumption, can disconnect from the macro grid and operate independently, and reconnect to the macro grid when needed.

### SUMMARY OF THE INVENTION

Embodiments of the invention include a series of branch circuit monitors that measure and store time-varying data on power usage at the branch circuit level certain embodiments, these data are stored locally, and are processed locally to provide actionable information on power usage. In other embodiments, these data are stored remotely in a network connected storage and processing facility (i.e., the cloud). In cloud connected embodiments, branch power monitors are connected to the cloud via a Wi-Fi data connection.

In one embodiment, an electronic monitoring system comprises an analog front end that receives as input the output of a current transformer connected to a load, wherein the analog front end converts the input to a digital value, a micro controller electrically connected to the analog front end that receives the digital value from the analog front end and pushes the digital value to a cloud server, and a power supply that provides power to the analog front end and the micro controller. This embodiment may also include an SD card that stores the digital value received from the micro controller; a micro controller pushes the digital value to the cloud server using Wi-Fi technology, and a battery that provides back-up power to an RTC in the event that the power supply fails.

In another embodiment, an electronic monitoring system comprises a first microcontroller that provides an analog front end that receives as input the output of a current transformer connected to a load, wherein the analog front end converts the input to a digital value. A second micro controller electrically connected to the first microcontroller that receives the digital value from the analog front end and pushes the digital value to a cloud server; and a power supply that provides power to the first and second microcontrollers. This embodiment may also include: an SD card interface that allows an attached SD card to store the digital value received at the second microcontroller, and where once an acknowledgement is received from the cloud server that it has successfully received the digital value, the digital value stored on the SD card data will be erased or over written; a real time clock that gives the second microcontroller the ability to time stamp the digital value, and that stores both a beginning time of an electrical failure and an end time of the electrical failure; a super capacitor connected to the real time clock that provides power backup to the real time clock in the event of an electrical outage; an LCD display that displays a status of a Wi-Fi connection connecting the electronic monitoring system to the cloud server; and a plurality of digital output channels that may be used to control solid state relays.

Other embodiments include a method of using an energy monitoring control system comprising the steps of: obtaining power consumption data from a plurality of nodes in an electrical grid, wherein the plurality of nodes is a plurality of branch circuits downstream from a metered connection to an electrical utility; converting the power consumption data from analog to digital; sending the power consumption data in a digital format to a cloud server via a Wi-Fi connection; analyzing the power consumption data with a cloud based software program, and determining both historical and instantaneous power consumption data for one or more of the plurality of nodes based on the analysis. Further steps of the method include: displaying data relating to either historical or instantaneous power consumption through a web-accessible display application; generating an alarm signal when a measured power consumption reaches a predetermined threshold, wherein the predetermined threshold corresponds to a price break point for an electrical utility's “peak demand” charge.

The method further including the steps of: on the basis of both the historical and instantaneous power consumption data, directing one or more switches in electrical communication with one or more nodes to disconnect from a source of power; on the basis of both the historical and instantaneous power consumption data, directing one or more switches in electrical communication with one or more nodes to connect to an auxiliary source of power; and calculating cost information on the basis of the power consumption data and pricing data from a connected electric utility.

Embodiments of the invention have certain advantages. According to embodiments of the invention, an energy monitoring device that has advanced capabilities with Wi-Fi and can connect to any available Access-Point and/or Router environment enables a user to monitor and control energy usage based on the collection of exact power consumption (and generation) data. An energy monitoring control system and method of use is also disclosed. The control system provides the ability for disconnecting a randomly defined local energy grid (“micro grid”), for example, within a facility, from the broader utility grid (“macro grid”) and operating the micro grid autonomously or independently based on analysis of data provided from one or a plurality of energy monitoring devices in order to avoid peak usage charges and more efficiently distribute energy usage.

### BRIEF DESCRIPTION OF THE DRAWINGS

The invention will be more fully understood by refuting to the following Detailed Description in conjunction with the Drawings, of which:

FIG. 1 is a diagram of an energy demand monitoring device, according to an embodiment.

FIG. 2 is another diagram of an energy demand monitoring device, according to an embodiment.

FIG. 3 is flow chart of an energy demand monitoring device, according to an embodiment.

FIG. 4 illustrates an internal view of an energy demand monitoring device, according to an embodiment.

FIG. 5 is a diagram of an input protection network of the energy demand monitoring device shown in FIG. 2.

FIG. 6 is a diagram illustrating a micro grid configuration with an energy demand monitoring and control system, according to an embodiment.

FIG. 7 is a diagram illustrating the functionality of an energy demand monitoring and control system, according to an embodiment.

FIG. 8 is a diagram illustrating the functional flow of an energy demand monitoring system, according to an embodiment.

FIG. 9 is a diagram illustrating the analysis and reporting flow of an energy demand monitoring system, according to an embodiment.

FIG. 10 is a diagram illustrating the functional flow for local control of a micro grid by an energy demand monitoring and control system, according to an embodiment.

FIG. 11 is a diagram illustrating the functional flow for cloud-based control of a micro grid by an energy demand monitoring and control system, according to an embodiment.

FIG. 12 is a flow chart showing the sequence used for setting the power limits, according to an embodiment.

FIG. 13 is a diagram of an energy demand monitoring device monitoring both power production and load consumption, according to an embodiment.

FIG. 14 is an example of a monthly report reflecting total power used provided by the energy demand monitoring system, according to an embodiment.

FIG. 15 is an example of a monthly report reflecting peak usage data provided by the energy demand monitoring system, according to an embodiment.

### DETAILED DESCRIPTION

Various embodiments of an energy monitoring device that has advanced capabilities with Wi-Fi and can connect to any available Access-Point and/or Router environment is described herein. The monitoring device is designed to provide the most accurate measurement, which is direct-node (sensors for each breaker, or circuit, or piece of automated, Internet-connected equipment), which provides exact data for each node or branch and can subtract that from the total(sum) in order to do a myriad of more productive measurements including pattern recognition. For Example, if a hotel has 150 rooms and 150 HVAC units, the data from the monitoring device disclosed herein can also effect determination of required maintenance, node (individual HVAC) failure, or failure prediction by comparative analysis. That alone can save users of the monitoring device considerable expenses as well as improve reliability. Monitors according to the invention are, in certain embodiments, Wi-Fi-enabled current measurement and control systems with analog front ends capable of connecting a plurality of differential channels providing current data input, periodically monitor the current data and send it to a cloud server via Wi-Fi interface. The monitors are also remotely controlled and configured from the cloud server.

The energy monitor device disclosed herein has three functions: monitor power consumption or production; analysis via cloud based or by limits programmed on the device itself; and control, where the device actually turns breakers or smart appliances on or off including sequencing function that turns on lights for example in a timed sequence that reduces peak demand(s).

A control system according to certain embodiments provides the ability for disconnecting a randomly defined local energy grid (“micro grid”), for example, within a facility, from the broader utility grid (“macro grid”) and operating the micro grid autonomously or independently based on analysis of data provided from one or a plurality of energy monitoring devices.

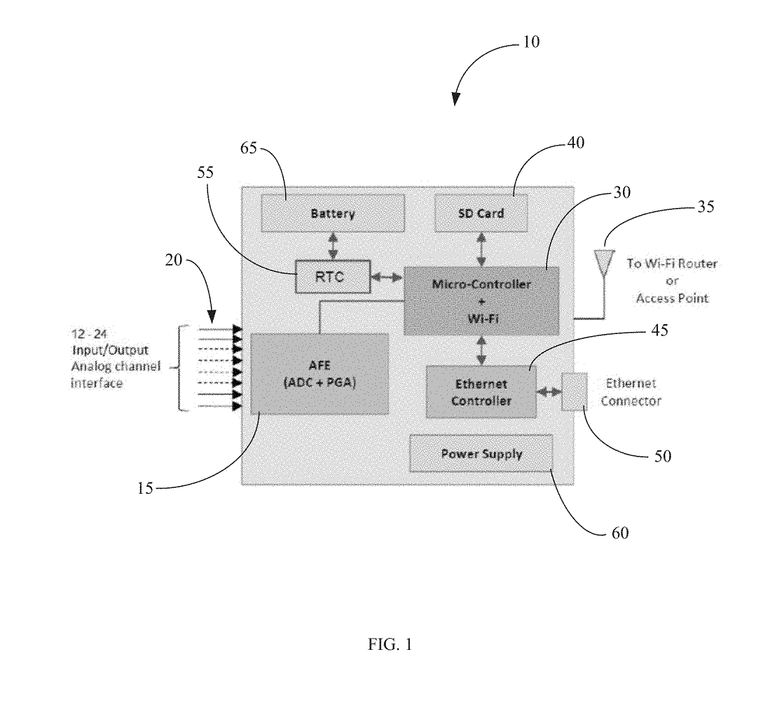

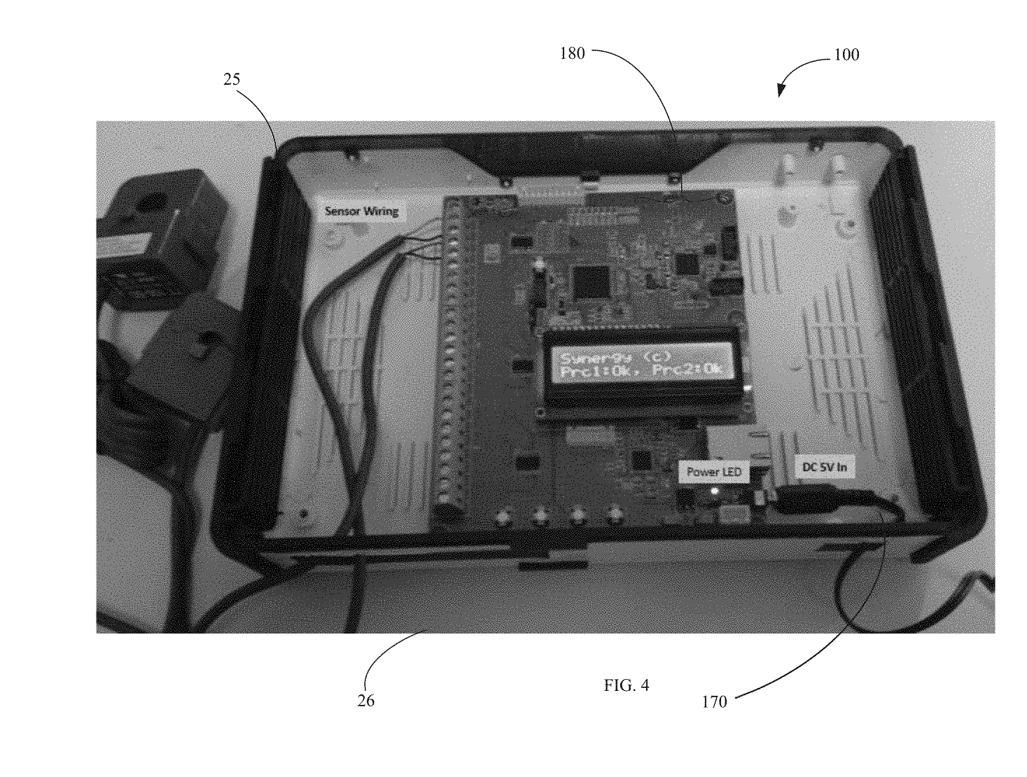

A monitor 10 for an electronic monitoring system is shown in FIG. 1. The monitor 10 includes an analog front end 15 which has analog to digital conversion and programmable-gain amplification capabilities. The analog front end 15 receives a plurality of inputs 20 from a series of current measuring devices 25. The current measuring devices 25, as shown in FIG. 4, may be clamp on type or fixed core current transformers with output in the mA range. One end of the current measuring device 25 is connected to the analog front end 15, while the other end connects to a load so that current measuring device 25 provides a stepped down current measurement of the load to the analog front end 15. The analog front end 15 captures the current consumption and processes the data to generate RMS current value measurements for each load to which a current measuring device 25 is connected. Current measuring devices 25 are attached to measure current in individual circuits present in an electrical installation, i.e., are placed on the load side of a meter and/or breaker panel. This allows for more granular usage data to be collected than is possible by measuring overall power use at the level of the meter.

The monitor 10 also includes a micro controller 30 that is electrically connected to the analog front end 15. The micro controller 30 receives the current measurements from the analog front end 15 and pushes the current measurements to a cloud server via a Wi-Fi router 35. The micro controller 30 is also electrically connected to an SD card storage device 40 which enables the monitor 10 to store the current measurement data locally in the event of a connection issue with the cloud server.

An Ethernet controller 45 and connector 50 are provided on the monitor 10 to enable connection with an external computing device. This Ethernet interface may be used by an installation engineer to configure the monitor 10 at the initial start-up. A real time clock (RTC) 55 is also provided to enable the monitor 10 to time stamp the current measurement data. The power supply 60 of the monitor 10 may consist of an external DC power adapter which supplies power to the various components of the monitor 10. A battery 65 provides backup power to the RTC in case of external power failure.

The monitoring software and/or firmware associated with monitor 10 allows for instantaneous and cumulative current measurements which are communicated over the internet via Wi-Fi to a cloud server, as described above. Cloud based software collects the transmitted current measurement data and analyzes for usage, trends, and control. Power consumption (instantons, RMS and historically aggregated data) is calculated on the basis of a-priori knowledge of the voltage associated with the current on the monitored branch circuits (i.e., 480, 240 or 120 V). Ideally, the installer logs, reports, or predetermines the voltage associated with each monitored branch because the current measuring devices 25 only measure current. Although the system has the capability to figure out the voltage for each branch circuit, initially it is desirable to know the incoming voltage of the service panel(s) to accurately measure the power consumed, or in the case of a generator, the amount of power produced.

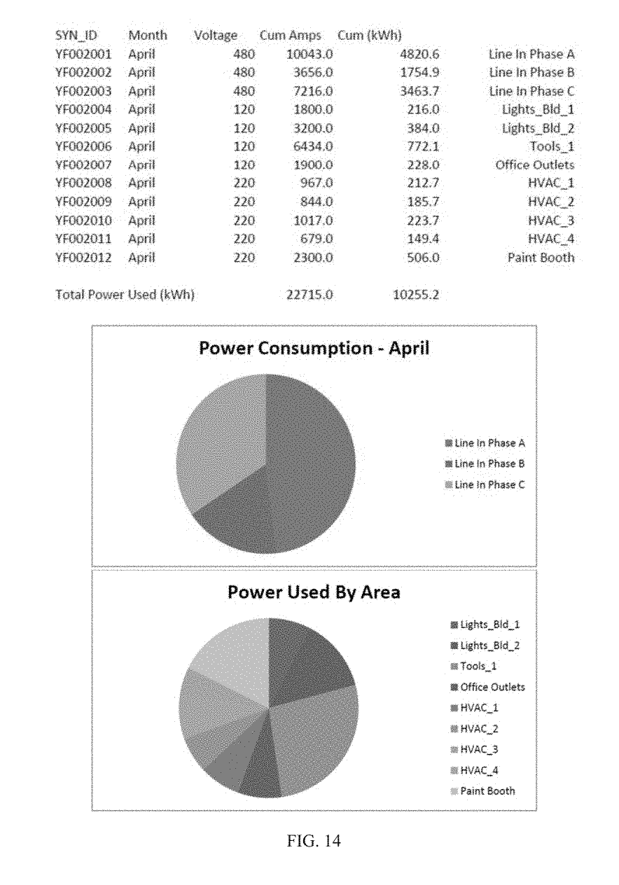

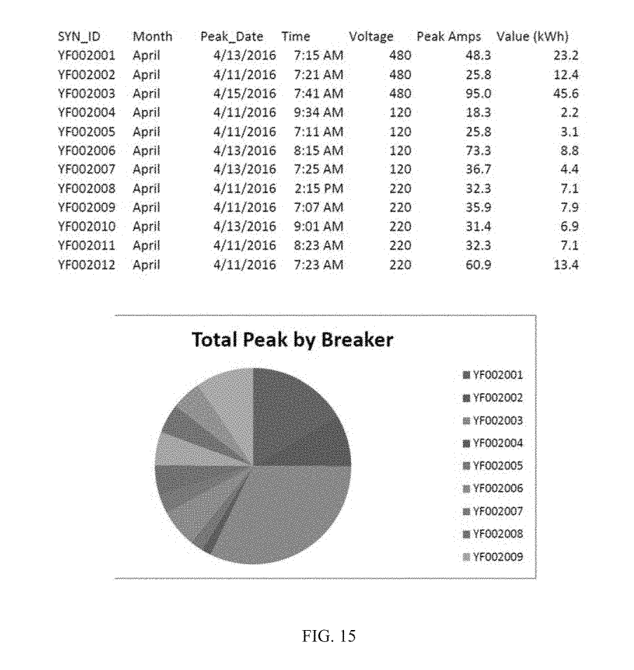

Power consumption reports are optionally provided on a daily, weekly, monthly, and/or annual basis depending on a particular user's needs. The cloud based software also provides a real time data monitoring portal for access by users, which provides not only information on power consumption, but also time-varying information on cost incorporating pricing data from the connected electric utility. Examples of monthly reports reflecting total power used and peak usage data are shown in FIGS. 14 and 15 respectively. Also, the system described herein has the ability to measure both usage and generation. The value of the energy measured in terms of positive and negative current indicates whether the energy is being consumed or generated. Where current flowing through a main node would ideally produce a positive value, and generation a negative value (positive and negative current).

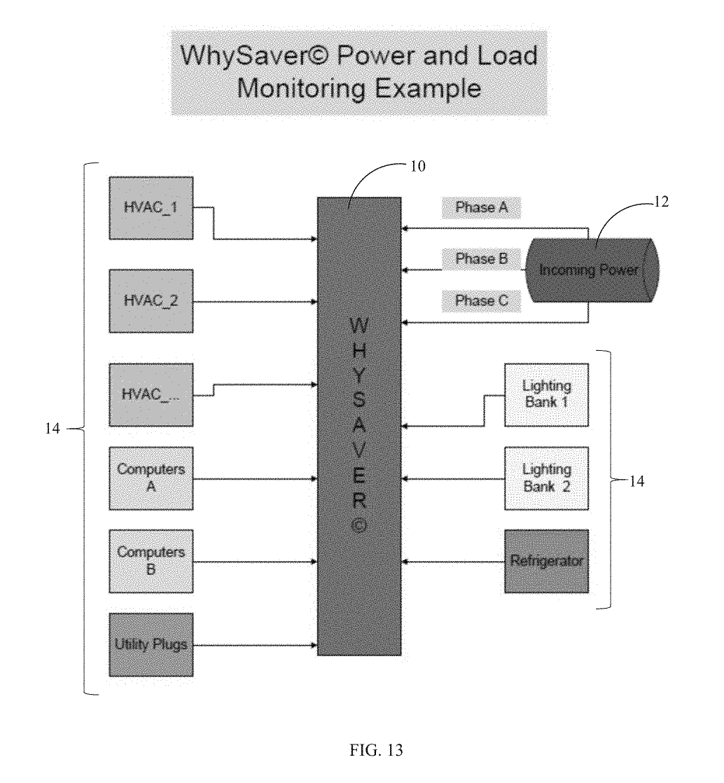

FIG. 13 shows a monitor 10 monitoring both power production and load consumption. The incoming power 12 to the system will be one polarity and the breakers connected to the appliances/loads 14 will be the opposite polarity. The incoming power 12 can be from the utility (macro grid) or from onsite generation (micro grid).

Additionally or alternatively, systems according to the invention can provide alarms to users when power consumption nears predetermined thresholds, e.g., thresholds corresponding to utility peak demand charges. A control system provides real-time demand offset controls (Tactical) and local demand offset controls (Strategic). Tactical energy demand is the immediate need for energy, whereas Strategic is a relatively predictable value developed over a period of time for general planning. For example, a new business or community may come online and five generators are all turned on to ensure a supply commensurate with the demand. By measuring the amount of energy used throughout a day, week, month, season, or year, the proportional or strategic amount of energy required and what drives it will be determined where the supply/supplies can be adjusted according to prevailing patterns, with an option for headroom. This reduces the need for excess energy generation and wasted fuel/transmission.

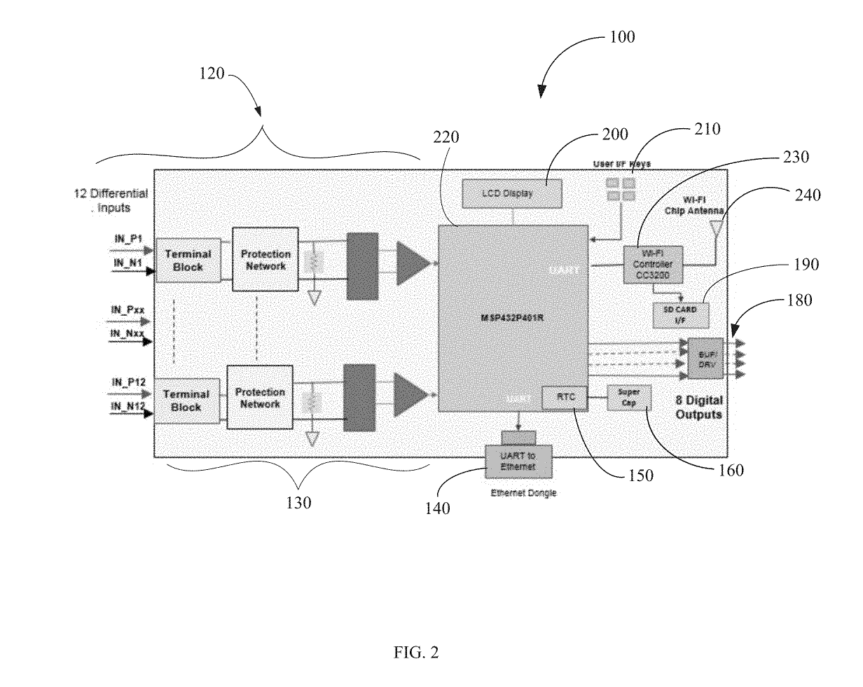

Another embodiment of an energy monitoring device is shown in FIG. 2. The monitor 100 has two primary functions: (i) to connect to the Wi-Fi network to maintain and facilitate the current data transmission to the cloud server; and. (ii) to connect to a number of current measuring transformers as inputs and capture the current consumption, via an analog front-end to, and to process that data to generate RMS current value measurements.

The present embodiment described in FIG. 2 has a twelve-input differential channel interface 120 from which the current measurement data is received via current measuring devices (sensors) 25, as shown in FIG. 4. The current measuring devices 25 are current measuring transformers, which are optionally either clamp on type and/or fixed core type, with output in the mA range. In installations where high current measuring devices are needed, a two-stage conversion is used before the measured current enters into the monitor 100 so that input to the monitor 100 will be in mA range. The preferred embodiment employs a maximum wire length of one meter for the wire 26 of current measuring device 25. Although using a wire 26 longer than one meter leads to less accuracy, longer wire lengths may be needed for some applications. Current measuring devices for three current ranges are used, depending on the application: 20 Amps, 200 Amps and 2000 Amps. Monitor 100 has an input number (twelve) as a multiple of three, so that the monitor 100 can be used for three-phase current measurements between load and ground.

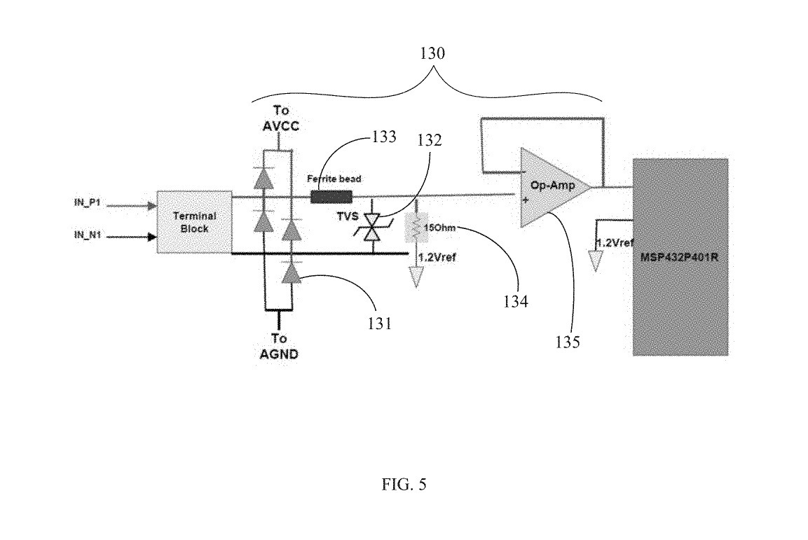

The input stage of monitor 100 is protected against the possibility of high current surges. In certain embodiments, clamp diodes and surge suppressors are employed for this purpose, but fuses are also used in other embodiments. Accordingly, a differential channel interface 120 may include a protection network 130, as shown in FIG. 5. The protection network 130 protects the input with stage diodes 131, which are used for clamping transients, transient voltage suppressors 132, and ferrite beads 133, which are used for suppressing or filtering high current spikes. The differential input from each measuring device is converted into a single end input with a terminating burden resistor 134 biased with a reference voltage of 1.2V. This input signal is then buffered by op-amp 135 and is supplied to the analog to digital converter (ADC) for further processing. In one embodiment, the ADC resolution is 14-bit or more in order to capture the output data of the current measuring devices 25.

Monitor 100 also may include an Ethernet connection 140, for example an RS232 interface or an Ethernet LAN interface. The Ethernet connection 140 may be used to facilitate configuration of the monitor 100 by an installation engineer who would connect an external computing device to the monitor 100 via the Ethernet connection 140. Similarly, the Ethernet connection 140 may be used to facilitate diagnostic or testing procedures, for example in the case of a noisy environment.

A real-time clock (RTC) 150 gives monitor 100 the ability to time stamp all data collected. Also, the RTC 150 stores both the time of electrical failure and time of power recovery in the event of an electrical outage. To this effect, the RTC 150 is connected to a super capacitor 160 that provides power backup to the RTC, effectively providing a self-contained and maintenance free monitor system as the monitor 100 is powered by an external DC power adapter at plug 170, which is shown in FIG. 4.

The monitor 100 may include digital output channels 180 with appropriate buffering and that are terminated to a connector interface. The digital output channels 180 may be used to control solid state relays or circuit breakers that have appropriate external drive capabilities. In the preferred embodiment, there are eight output ports that can be used individually or multiplexed to control more than twelve pieces of equipment.

In the absence of a Wi-Fi connection or in the event of an issue connecting to the cloud server, data collected by the monitor 100 is stored on an SD card which connects to the monitor 100 via an SD card interface 190. The inclusion of SDRAM memory is two-fold: 1) for instances where data is wiped out at a cloud server; and 2) for instances where data is interrupted going to the cloud server. The cloud server can poll the monitor 100 for missing data or the SD card can be removed and the encrypted data can be physically taken back to the database. In the preferred embodiment, the SD card will be 8 GB and able to hold approximately 8 years' worth of data. Additionally, the data stored on the SD card is sent/re-sent to the cloud server once the Wi-Fi or cloud server connection is re-established, and once an acknowledgement is received from the cloud server that it has successfully received the offline data, the SD card data will be erased or over written. The monitor 100 may also connect to a router or access point through a physical CAT-5 cable connection.

The monitor 100 may include an LCD display 200 that displays monitor information such as: the status of the monitor with respect to the Wi-Fi connection and strength; the number of inputs reporting (i.e. recording and transmitting data); and the number of digital outputs in use. The monitor 100 may also include user interface keys 210 that can be used for various purposes, as non-limiting examples, the user interface keys 210 may be used to enable test mode or to scroll through registers to check whether the monitor is recording data correctly or not.

The monitor 100 employs two microcontrollers, one to address the analog front-end needs, and another to connect to the cloud server and manage the network connection. The analog front end (AFD) microcontroller 220, for example, an MSP432 microcontroller from Texas Instruments, connects to the differential channel interface 120 and processes RMS current measurements based on the inputs from the differential channel interface 120. Additionally, the AFD microcontroller 220 is responsible for operations of: the LCD display 200; the user interface keys 210; the RTC 150; and the digital output channels 180, otherwise known as general purpose input/output (GPM).

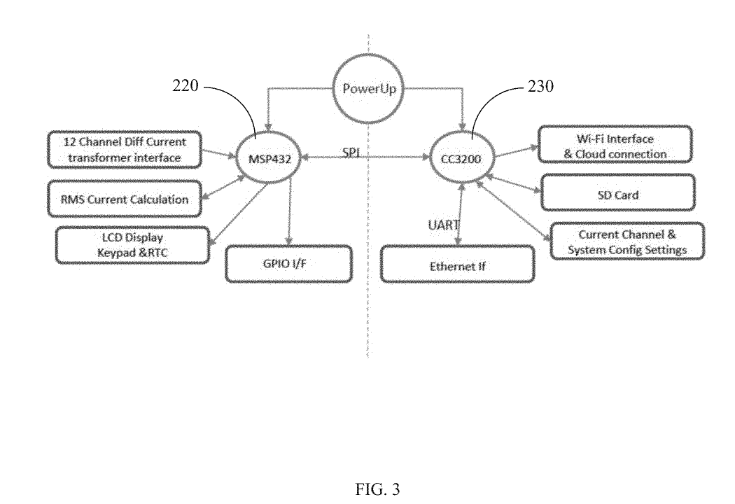

The network microcontroller 230, for example, a CC3200 microcontroller from Texas Instruments, connects to the cloud server via a Wi-Fi interface 240. The network microcontroller 230 manages the network connection and maintenance as well as operates the SD card interface 190 to retain data during unsuccessful cloud server connections. The network microcontroller 230 also operates the Ethernet connection 140 and the monitor configuration settings. FIG. 3 shows a flow chart of the monitor 100, its two microcontrollers 220, 230 and their corresponding roles. Transfer of data between the two microcontrollers 220, 230 occurs by Serial Peripheral Interface (SPI) bus.

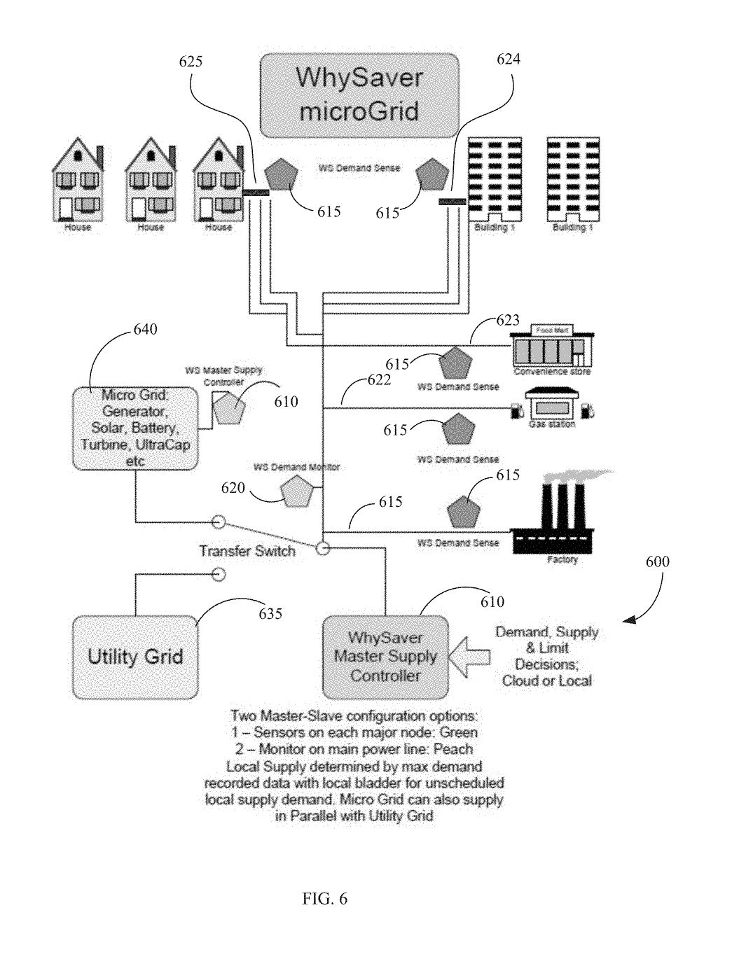

An energy monitoring control system that employs the energy demand monitor devices previously described is illustrated in FIG. 6. FIG. 6 illustrates a “microgrid” using energy demand monitors (615, 620) to enable load balancing and control of a local area of an electrical utility grip that may become disconnected from the macro-grid 635. This control is enabled by control system 600, which operates the micro grid autonomously or independently based on the data and the analysis of that data provided from one or a plurality of energy monitoring devices, and where the micro grid 640 receives power from an alternative power source (e.g., a generator, solar, battery, turbine, ultra-capacitor, etc.). The operation of the micro-grid will now be described.

It is instructive to consider the macro grid as a giant “bladder” (i.e., storage pool) of energy that must have power for all potential demands, wherever they come from on the Grid at any time. The requirement that the macro grid have this available capacity inevitably results in wasted and unused energy. The cost of this waste is borne by all users/customers/subscribers on the macro grid. A micro grid is inherently more efficient because (1) transmission losses (assuming local power generation) are significantly lower and (2) the “bladder” or pool of available power will necessarily be smaller, resulting in less waste of available energy that is not consumed. Another benefit of a micro grid is lower potential effect of a power loss from loss of the macro grid or distant generation failure resulting in brown-outs, rolling outages, or other unreliable supply.

The main purpose of the energy monitoring control system technology is energy efficiency and conservancy. With business and residential consumer costs at 5 to 20 times the wholesale cost of energy in states such as California, the only barriers to implementation of a micro grid are one-time local infrastructure costs and the comfort of relying on the macro grid.

Referring back to FIG. 6, the control system 600 comprises a master supply controller 610; where multiple energy demand monitors are employed, a master-slave order will be predetermined and the master monitor will become the main generation control engine where cloud control is not required (i.e. the master supply controller). FIG. 6 shows two master-slave configuration options. Option one is having sensors 615 on each major node 621, 622, 623, 624, 625. Option two is a single monitor 620 located on the main power line.

Referring now to FIGS. 6-11, a method of use of the control system 600 is described. The data measured from the nodes 621, 622, 623, 624, 625 (power consumption per node and total power consumption) of a business will initially come to a cloud server 630 where it is stored for analysis of consumption and time in both RMS data form and Peak data form. This can be done by monitoring all possible nodes/circuit-breakers, or a sub-set of key nodes, or in the case of a multi-tenant business (e.g., an apartment or a mall), usage of individual units for each unit or cost center. Peak data is useful to determining “peak-demand” where utilities monetize demand charges. RMS data is useful to determining energy/power used or generated, where onsite or onsite controlled generation (solar, gas, diesel, battery storage) is available.

In the case of a micro grid 640, communication to the cloud may be disconnected temporarily or the service otherwise will be self-contained. It may or may not be connected to the macro grid 635 (Utility service). The control system 600 can have patterns of learned usage and generation downloaded from the cloud server 630 to work as a local system energy monitor and allocation control providing seamless autonomous energy for one or more sub-sets of micro-Grids.

A simple example of usage/demand can be approximated by the equation: M=P(x 1+x2+x3 . . . ) where M is the sum at any given point of demand by the sum of nodes and/or the aggregated demand based on maximum consumption of each node. Generation/provision could be established by as little as M+10% with peak shaving and demand prediction from actual/established data usage patterns.

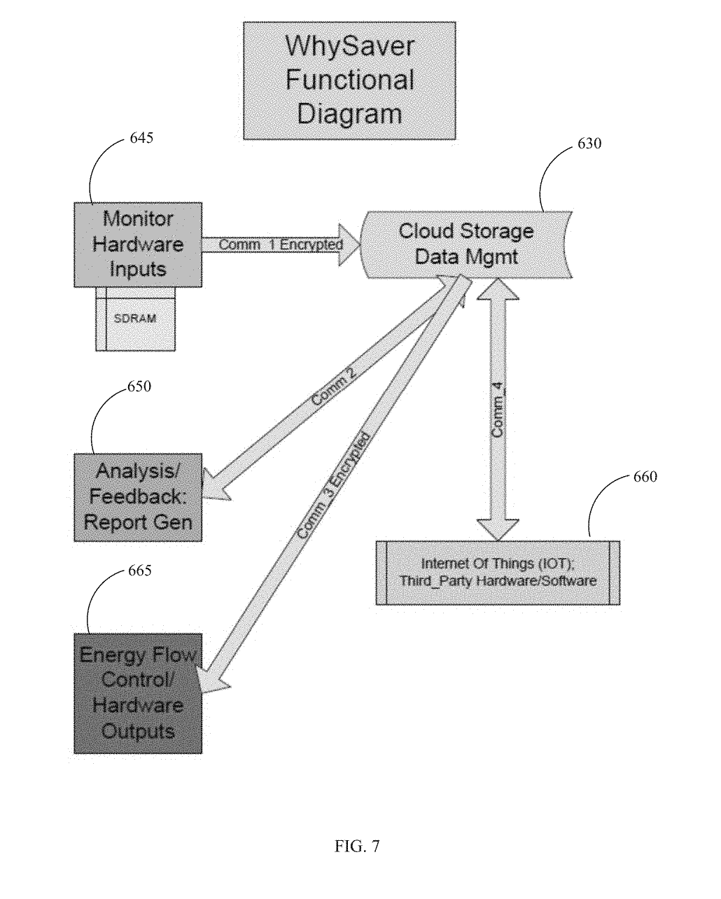

Data collected by the control system 600 will provide actual operating requirements based on prevailing usage patterns. FIG. 7 shows a functional flow diagram of how these usage patterns are collected and analyzed. At block 645 an energy monitoring device, as described above, sends power usage data to the cloud server 630. At block 650 the software located on the cloud server 630 analyzes and provides reports based on the power usage data. At block 655 the cloud server software provides operating instructions based on the analysis. At block 660 third party software and/or hardware may be incorporated into the control system 600 to provide additional options or data points (e.g. the internet of things (IOT)).

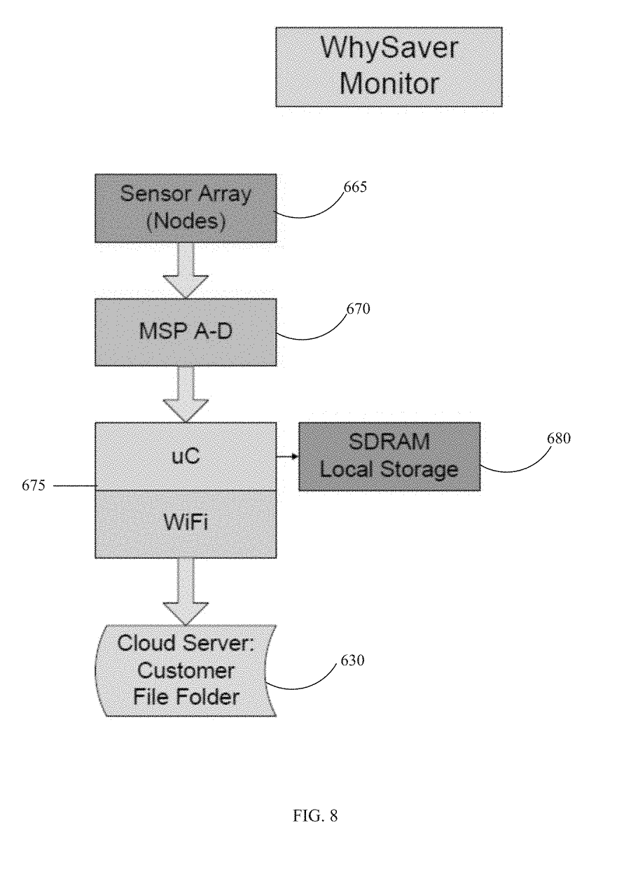

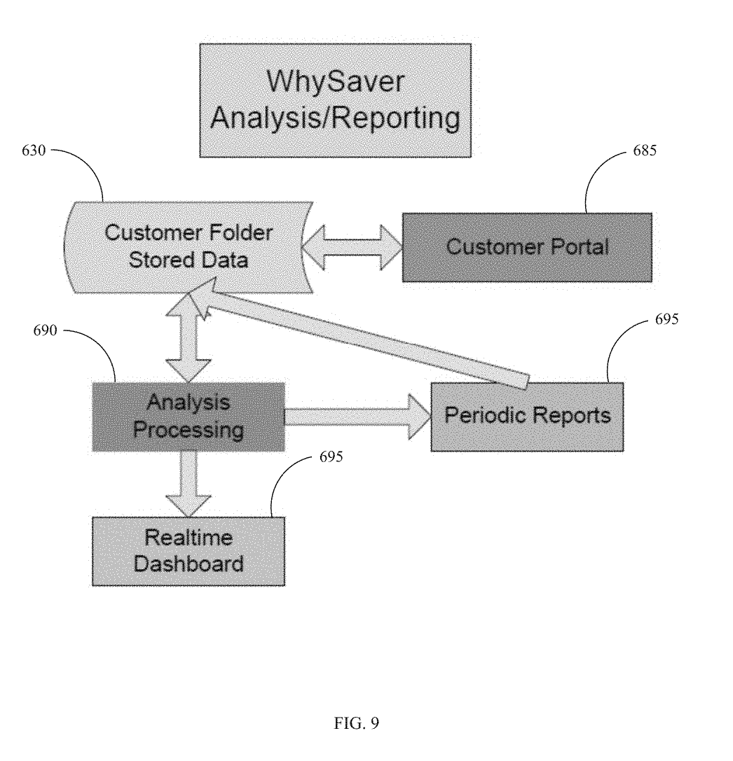

FIG. 8 shows a functional flow diagram of the energy monitoring device sending power usage data to the cloud server 630 (block 645 of FIG. 7). At block 665 sensors gather current use data which is sent to a processor for analog to digital conversion at block 670. The data is sent to a microcontroller at block 675, which stores the data locally at block 680. The data is also sent via a Wi-Fi connection to the cloud server 630. FIG. 9 shows the analysis flow (block 650 of FIG. 7) of the power usage data in greater detail. At block 685 the customer has access to their stored data which can be retrieved at any time via a customer portal. At block 690 the cloud based software analyzes the stored power usage data and provides periodic reports at block 695. Block 690 also provides a real-time dashboard for the customer that indicates, for example, live power consumption per node for a given time frame, total power consumption, estimated power consumption for the day, estimated cost for the day, estimated monthly cost, etc.

The prevailing usage patterns can be used to smooth out the peak demands through simple control/sequencing of when nodes are allowed to activate (preventing all or multiple high usage nodes from activating simultaneously) or activating onsite generation or energy storage provision from batteries, SuperCaps, UltraCaps, etc. This is particularly useful in avoiding “peak demand” charges from a connected utility. In particular, electrical utilities often charge customers increasing rates for energy delivered above certain “peak demand” power thresholds. Systems according to the invention may be programed to have awareness of these peak demand thresholds, and can either disconnect certain loads when power consumption nears a break-point, or can connect auxiliary power sources to the local network to reduce power being sourced from the utility. These occurrences can also be predicted on the basis of historical use patterns, which can be downloaded for local control of usage (node activation or sequencing) and locally available generation or storage. Other data, such as real-time weather information (i.e., warm weather, which would be expected to increase HVAC associated loads) is used in certain embodiments to predict when certain use thresholds are likely to be approached. Additionally, usage data for individual branch circuits within an installation (i.e., at a scale smaller than the micro grid), can be used to balance a load across installation's circuits, e.g., by disconnecting certain electrical loads from one circuit, and reconnecting those loads to another, less-used circuit.

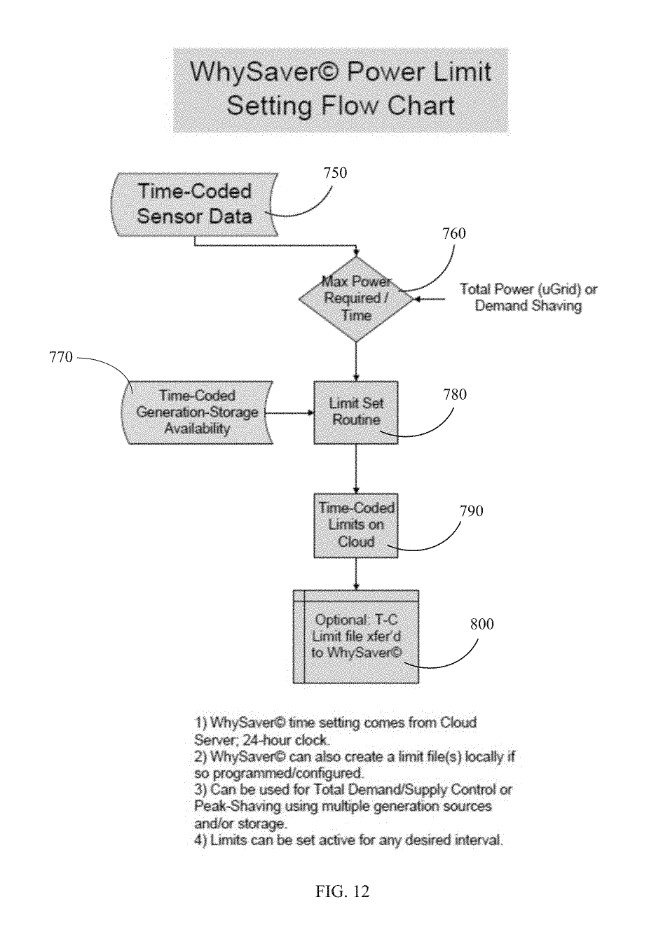

FIG. 12 shows a flow chart showing the sequence used for setting the power limits used to smooth out the peak demands as described above. At block 750 the time coded sensor data located on the cloud server is analyzed to determine max power required at block 760 where the total power available from generations sources is taken into account. At block 770 the time coded power generation of the micro grid is taken into account along with the storage availability of the system, when determining the limit set routine at block 780. The time coded limits are stored on the cloud server at block 790, additionally or alternatively, the time coded limit file is transferred to the energy monitoring device at block 800.

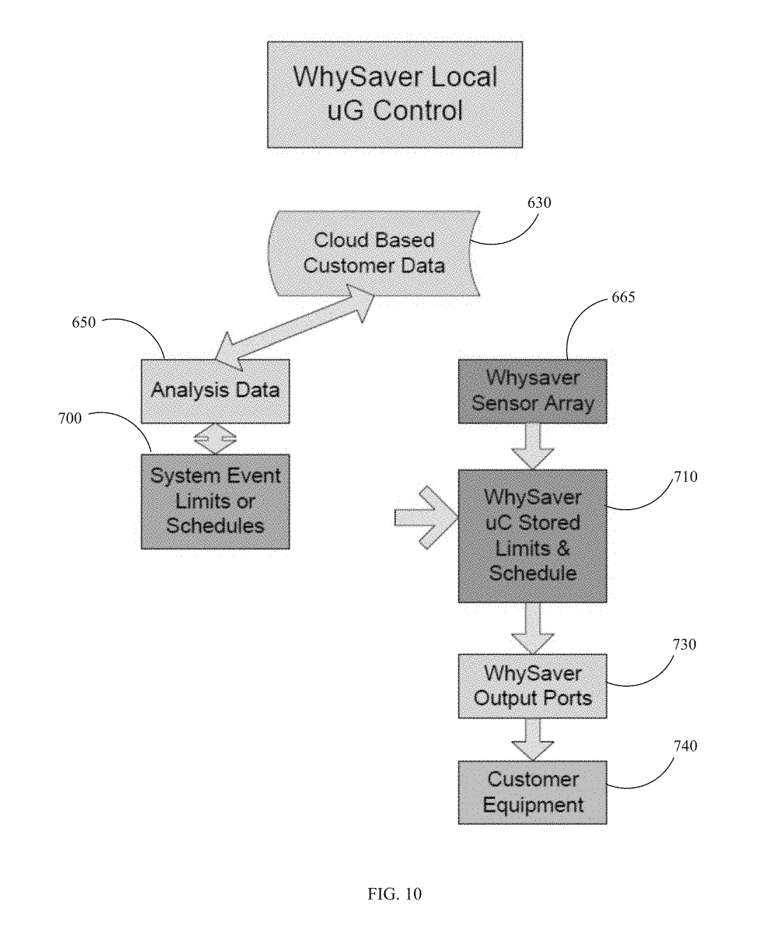

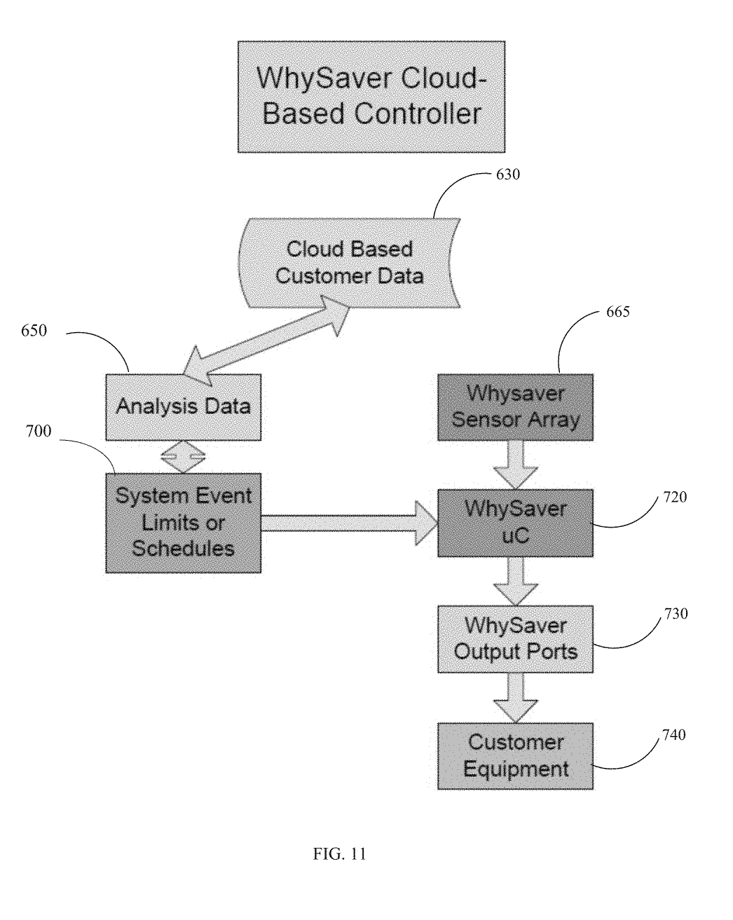

FIGS. 10 and 11 show the flow for control of nodes or customer equipment when controller is not connected to the cloud server 630 (FIG. 10) and when the controller is connected (FIG. 11), At block 650 the software located on the cloud server 630 analyzes the power usage data and calculates system events and limits, shown at block 700. In the case where the controller is not connected to the cloud server 630, the limits are downloaded to the microcontroller at block 710, as shown in FIG. 10. In the case where the controller is connected to the cloud server 630, as shown in FIG. 11, the limits are sent from the cloud server to the microcontroller at block 720. For both cases, the limits determine which output ports are activated at block 730, which in turn limits the nodes or customer equipment that is allowed to activate, as shown at block 740.

Changes (increases) in demand for non-cloud connected control systems can be established and limits updated where demand increases by local, cloud, or learning routines, where changes to high limits are repeated. Decreases in demand do not require similar changes, but limits can also be re-programmed by repeated changes that are or are not seasonal (temporary or permanent).

Determining peak demand in macro or micro grid-connected applications is simply using a database search for the highest value for a given period of time. This provides the most useful limit for costing as well as demand or peak-shaving where control of generation, storage, or node activation is determined optimally beneficial. For example, in Excel: MAX x1:xN (or MAX (A:A) where A is a column of data or MAX (1:1) where 1 is a row of data). Determining usage is simply a summation for a determined period of time (day, week, month, year, etc.) of collected monitored data. For example, in Excel: SUM x1:xN (or SUM (A:A) where A is a column of data or SUM (1:1) where 1 is a row of data)

The invention should not be viewed as being limited to the disclosed embodiments. Envisioned claims may be directed to at least a system and/or method for fabrication of an energy demand monitoring and control system, an article of manufacture produced with the use in such system and/or method, and a computer program product for use with a system and/or method of an embodiment of the invention indeed, while the preferred embodiments of the present invention have been illustrated in detail, it should be apparent that other modifications and adaptations to those embodiments might occur to one skilled in the art without departing from the scope of the present invention.

1. An electronic monitoring system comprising
an analog front end that receives as input the output of a current transformer connected to a load, wherein the analog front end converts the input to a digital value;
a micro controller electrically connected to the analog front end that receives the digital value from the analog front end and pushes the digital value to a cloud server; and
a power supply that provides power to the analog front end and the micro controller.

2. The electronic monitoring system according to claim 1, further comprising an SD card that stores the digital value received from the micro controller.

3. The electronic monitoring system according to claim 1, wherein the micro controller pushes the digital value to the cloud server using Wi-Fi technology.

4. The electronic monitoring system according to claim 1, further comprising a battery that provides back-up power to an RTC in the event that the power supply fails.

5. An electronic monitoring system comprising
a first microcontroller that provides an analog front end that receives as input the output of a current transformer connected to a load, wherein the analog front end converts the input to a digital value;
a second micro controller electrically connected to the first microcontroller that receives the digital value from the analog front end and pushes the digital value to a cloud server; and
a power supply that provides power to the first and second microcontrollers.

6. The electronic monitoring system according to claim 5, further comprising
an SD card interface that allows an attached SD card to store the digital value received at the second microcontroller.

7. The electronic monitoring system according to claim 6 wherein once an acknowledgement is received from the cloud server that it has successfully received the digital value, the digital value stored on the SD card data will be erased or overwritten.

8. The electronic monitoring system according to claim 5, further comprising
a real time clock that gives the second microcontroller the ability to time stamp the digital value, and that stores both a beginning time of an electrical failure and an end time of the electrical failure; and
a super capacitor connected to the real time clock that provides power backup to the real time clock in the event of an electrical outage.

9. The electronic monitoring system according to claim 5, further comprising
an LCD display that displays a status of a Wi-Fi connection connecting the electronic monitoring system to the cloud server.

10. The electronic monitoring system according to claim 5, further comprising
a plurality of digital output channels that may be used to control solid state relays.

11. A method of using an energy monitoring control system comprising:
obtaining power consumption data from a plurality of nodes in an electrical grid;
converting the power consumption data from analog to digital;
sending the power consumption data in a digital format to a cloud server via a Wi-Fi connection;
analyzing the power consumption data with a cloud based software program, and
determining both historical and instantaneous power consumption data for one or more of the plurality of nodes based on the analysis.

12. The method of claim 11, further including the step displaying data relating to either historical or instantaneous power consumption through a web-accessible display application.

13. The method of claim 11, wherein the plurality of nodes is a plurality of branch circuits downstream from a metered connection to an electrical utility.

14. The method of claim 11, further including the step of generating an alarm signal when a measured power consumption reaches a predetermined threshold.

15. The method of claim 14, wherein the predetermined threshold corresponds to a price break point for an electrical utility's “peak demand” charge.

16. The method of claim 11, further including the step of, on the basis of both the historical and instantaneous power consumption data, directing one or more switches in electrical communication with one or more nodes to disconnect from a source of power.

17. The method of claim 11, further including the step of, on the basis of both the historical and instantaneous power consumption data, directing one or more switches in electrical communication with one or more nodes to connect to an auxiliary source of power.

18. The method of claim 11, further including the step of calculating cost information on the basis of the power consumption data and pricing data from a connected electric utility.
